(19) United States
(12) Patent Application Publication
(10) Pub. No.: US 2023/0373715 A1
(43) Pub. Date: Nov. 23, 2023

(54) Automated Trash Can Device

(71) Applicant: Ronald W. Tank, JR., Cambridge, OH (US)

(72) Inventor: Ronald W. Tank, JR., Cambridge, OH (US)

(21) Appl. No.: 18/154,331

(22) Filed: Jan. 13, 2023

Related U.S. Application Data
(60) Provisional application No. 63/342,664, filed on May 17, 2022.

(51) Int. Cl. B65F 1/14; B65F 1/16

(52) U.S. Cl. CPC B65F 1/1473; B65F 1/1426; B65F 1/163; B65F 2210/165; B65F 2210/168; B65F 2210/128; B65F 2210/139

(57) ABSTRACT

The present invention relates to a novel automated trash can device. The device is an improved trash can comprised of a base component with a battery component, a GPS, and a garage door opener. The device is wirelessly paired to a mobile application. The trash can device may be stored in a charging dock or station when being filled with trash and/or charging. In use, the trash can device will open the garage door, then proceed to the destination near the curb or end of the driveway. The route is optimized via GPS, ensuring the receptacle moves back and forth from the garage to the curb/driveway correctly. After being emptied, the trash can device then returns to the charging dock or station and closes the garage door.

### CROSS-REFERENCE TO RELATED APPLICATION

The present application claims priority to, and the benefit of, U.S. Provisional Application No. 63/342,664, which was filed on May 17, 2022, and is incorporated herein by reference in its entirety.

### FIELD OF THE INVENTION

The present invention relates generally to the field of automated trash can devices. More specifically, the present invention relates to an improved automated trash can device that provides users with a specialized trash receptacle system that can automatically move from a home or garage to a street curb for trash pickup. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in automated trash can devices. Generally, constantly moving trash receptacles from a home, a garage, etc., to the end of a driveway or the street can be frustrating and inconvenient. People with physical limitations, such as those with an injury or the elderly, may be unable to move their trash receptacles to the curb for pickup. Further, taking out the trash during inclement weather can also be frustrating.

Additionally, trash cans have come a long way in both style and function to accommodate busy and modern lifestyles. However, the chore of taking out the garbage is unpleasant, and there are limited products available on the market that make this process easier and more efficient. Also, when people are on vacation, their trash cans may be left on the curb for an extended period of time until they return.

Therefore, there is a need for a device that allows a user to control trash can movement to and from a curb. It would be desirable to provide a trash can device that can automatically move from a home or garage to a street curb for trash pickup. Further, there is a need in the art for a trash can device that allows users to automate the movement of their trash receptacles to the street curb for pickup with minimal effort required by the user.

Therefore, there exists a long-felt need in the art for an automated trash can device that provides users with a specialized trash receptacle system that can automatically move from a home or garage to a street curb for trash pickup. There is also a long-felt need in the art for an automated trash can device that utilizes a GPS to identify a route for traveling back and forth from a garage to the end of a driveway or street curb. Further, there is a long-felt need in the art for an automated trash can device that automates trash pickup from public sanitation employees, eliminating the need for homeowners to manually take their trash to the street curb. Moreover, there is a long-felt need in the art for a device that features a charging dock that stores the receptacle when it needs to be filled with trash. Further, there is a long-felt need in the art for an automated trash can device that prevents users from having to worry about their outdoor trash receptacles, ensuring they only move back and forth from two different locations. Finally, there is a long-felt need in the art for an automated trash device that provides users with a device that automates movement of their trash receptacles with minimal effort required by the user.

The subject matter disclosed and claimed herein, in one embodiment thereof, comprises an automated trash can device. The device is an improved trash can comprised of a base component with a battery component, a GPS, and a garage door opener. The device is wirelessly paired to a mobile application. The trash can device may be stored in a charging dock or station when being filled with trash and/or charging. In use, the trash can device will open the garage door, then proceed to the destination near the curb or end of the driveway. The route is optimized via GPS, ensuring the receptacle moves back and forth from the garage to the curb/driveway correctly. After being emptied, the trash can device then returns to the charging dock or station and closes the garage door. Thus, users automate the movement of the trash can device to the street curb/driveway for pickup with minimal effort required.

In this manner, the automated trash can device of the present invention accomplishes all of the foregoing objectives and provides users with a device that prevents users from having to worry about their outdoor trash receptacles. The device provides users with a convenient way to automate trash pickup from public sanitation employees. The device provides users with a specialized trash receptacle system that can automatically move from a home or garage to a street curb for trash pickup.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automated trash can device. The device is an improved trash can device that, in use, will open the garage door, then proceed to the destination near the curb or end of the driveway. After being emptied, the trash can device then returns to the house or garage and closes the garage door. Thus, users automate the movement of the trash can device to the street curb/driveway for pickup with minimal effort required.

As shown in one embodiment, the automated trash can device comprises a base component of varying sizes and shapes. Generally, the base component is shaped as a rectangular prism, such as a conventional trash can, but can be any size and shape as is known to one of ordinary skill in the art, such as cylindrical, oval, square prism, etc. Typically, the base component comprises a front wall, a rear wall, two opposing side walls, and a bottom component. The front wall, rear wall, two opposing side walls, and the bottom component act to form a hollow interior cavity and opening. The hollow interior cavity is utilized for retaining trash, trash bags filled with trash, and other items which are placed within the opening and into the hollow interior cavity.

In one embodiment, the base component comprises an inner shell or liner component. The base component can be made integrally, monolithically, or separate from the inner shell or liner. In some embodiments, the inner shell or line component can be removable. Typically, the inner shell or liner component is made of the same material as the outer base component, but does not have to be and can be manufactured of any suitable material as is known in the art.

In one embodiment, the base component further comprises a lid component covering the opening. The lid component acts to secure the contents of the trash can device and can be secured via a press fit assembly, latch, lock, or other securing means as is known in the art. Further, the lid component comprises hinges which act to allow opening and closing of the lid on the base component and act to allow access to the opening and thus the hollow interior cavity of the base component.

In one embodiment, the base component can also include a foot recess positioned at a lower portion of the base component. The foot recess can be formed from a shaped portion of the base component or can be made integrally with the bottom of the base component. The foot recess can extend inwardly into the general outer periphery of the base component. Additionally, the foot recess can extend upwardly from the bottom. Further, a foot plate can be optionally provided at a bottom of the foot recess and can extend from the bottom of the base component to control opening and closing of the lid component.

In one embodiment, the base component comprises a plurality of wheels. The plurality of wheels may be disposed at a bottom component of the base component and may allow the automated trash can device to roll in any direction. In other words, the plurality of wheels may rotate, swivel, and pivot, based on a user's preference and/or commands. Specifically, the plurality of wheels may rotate, swivel, and pivot when the motor is activated. The plurality of wheels can be secured to an underside of the bottom component via any suitable securing means as is known in the art, such as bolts, screws, pins, etc. Further, any suitable wheels can be utilized as is known in the art, such as castors, rollers, swivel wheels, etc. In one embodiment, the plurality of wheels are secured to a transport unit and can be separated from the base component if needed, to allow for ease in emptying the device when full or for cleaning as needed.

In another embodiment, the base component comprises a sensor component, a processor, and a motor, but is not limited thereto. The sensor component may be disposed on the base component and may communicate with a plurality of sensor guides, which may be placed along a path (i.e., a ground, a floor, a driveway, a street, etc.) in a particular direction and/or configuration. The sensor component can also detect nearby objects to allow the device to avoid such objects when in motion.

In one embodiment, the base component comprises a plurality of exterior lights or reflectors for use in the dark.

In one embodiment, the processor may be disposed on or within the base component, and may be a CPU, a microprocessor, a controller, or any other type of computing device that may process programs and/or instructions, and which may control the other electrical components within the automated trash can device. The processor may be connected to the sensor component and the motor, such that the processor causes the motor to be activated (i.e., turned on) when the processor, which includes a transmitter/receiver, receives a signal from a mobile device, for example.

In another embodiment, the motor may be any type of motor and/or control device to control the plurality of wheels to rotate and pivot.

In yet another embodiment, the mobile device or smart device may be a cellular telephone, a remote control, or any other device that may have wireless communication capabilities and may be connected to the internet. The mobile or smart device may perform any type of wireless communication, including, but not limited to, WIFI, BLUETOOTH, RFID, NFC, etc. The device further includes a wireless communication module and additional sensors which would allow the device to pair with a mobile application on a mobile or smart device. Once paired, a user could control the automated trash can device via the mobile application.

As such, the user may use a mobile or smart device to input and/or program a date and time that the automated trash can device is scheduled to move down a path designated by the plurality of sensor guides, and a signal may be sent from the mobile device to the transmitter/receiver such that the processor (which may include a storage device) stores the date and time that the automated trash can device is scheduled to move. Alternatively, the mobile or smart device may send a signal to the transmitter/receiver to control the automated trash can device to move immediately.

When the transmitter/receiver receives the signal from the mobile/smart device to move, the processor may activate the motor, such that the plurality of wheels begin rotating. The sensor component causes the automated trash can device to stay along a path designated by the plurality of sensor guides, such that the automated trash can device may stay between the plurality of sensor guides. As such, the motor may cause the plurality of wheels to rotate and pivot, thereby causing the automated trash can device to move along the path designated by the plurality of sensor guides (i.e., between the plurality of sensor guides), until the automated trash can device reaches an end of the path designated by the plurality of sensor guides. Likewise, the automated trash can device may be programmed and/or controlled to return back to the beginning of the path designated by the plurality of sensor guides. In other words, the automated trash can device may move back and forth along the path designated by the plurality of sensor guides.

In an alternative embodiment, the processor may include a GPS unit that may be programmed and/or controlled by the mobile or smart device to move to a predetermined location based on an input of the user. In other words, the GPS unit may be a global positioning device that communicates with satellites in order to determine a location of the automated trash can device. The route of the device is optimized via GPS, ensuring the trash can device moves back and forth from the garage to the curb/driveway correctly. As such, the sensor component and the plurality of sensor guides may not be required when the GPS unit is included in the processor. Also, a display screen (which may also be an input unit/touch screen) on the mobile or smart device may display the automated trash can device on a map as it is moving.

Furthermore, in one embodiment, the automated trash can device may have an input unit including buttons or a touch screen (preferably waterproof) disposed thereupon to program the processor directly/manually, instead of requiring the processor to communicate with the mobile or smart device.

In another embodiment, the base component comprises a garage door opener which acts to open and close the garage door, thus allowing a user to program the opening and/or closing of the garage door when the automated trash can device needs to leave the home or garage to travel down to the street curb and back.

In another embodiment, the base component comprises a battery component.

In yet another embodiment, the base component rests on or against a charging dock or station within a home or garage. The charging dock or station can be any suitable shape or size and allows the device to be stored on the station and charged, when not in use. The charging dock or station recharges the battery component and retains the device, allowing a user to fill the trash can device with trash, as needed.

In yet another embodiment, the automated trash can device comprises a plurality of indicia.

In yet another embodiment, the automated trash can device is manufactured from lightweight metals or heat-resistant plastics or polymers, such as polypropylene, polycarbonate, or acrylonitrile-butadiene-styrene (ABS), etc.

In yet another embodiment, a method of automatically moving a trash receptacle from a garage docking station to a street curb for trash pickup is disclosed. The method includes the steps of providing an automated trash can device comprising a base component with a battery component, a GPS, and a garage door opener, wherein the device is wirelessly paired to a mobile application. The method also comprises filling the trash can device with bags of trash. Further, the method comprises programming the trash can device to open the garage door at a predetermined date and time. The method comprises optimizing the route for the trash can device via GPS, ensuring the device moves back and forth from the garage to the street curb correctly. Finally, activating the trash can device, which opens the garage door at a predetermined time and date, the device proceeds to the street curb, and after being emptied, returns to the charging station, and closes the garage door.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the automated trash can device of the present invention docked on the charging station in accordance with the disclosed architecture;

FIG. 2 illustrates a perspective view of one embodiment of the automated trash can device of the present invention showing a trash bag inserted into the receptacle in accordance with the disclosed architecture;

FIG. 3 illustrates a perspective view of one embodiment of the automated trash can device of the present invention showing the device being moved automatically from the docking station in accordance with the disclosed architecture;

FIG. 4 illustrates a perspective view of one embodiment of the automated trash can device of the present invention showing the device moving to the street curb in accordance with the disclosed architecture;

FIG. 5 illustrates a perspective view of the one embodiment of the automated trash can device of the present invention in use in accordance with the disclosed architecture;

FIG. 6 illustrates a block diagram of the wireless communication module in communication with a smart device and the automated trash can device of the present invention in accordance with the disclosed architecture; and

FIG. 7 illustrates a flowchart showing the method of automatically moving a trash receptacle from a garage docking station to a street curb for trash pickup in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an automated trash can device that provides users with a specialized trash receptacle system that can automatically move from a home or garage to a street curb for trash pickup. There is also a long-felt need in the art for an automated trash can device that utilizes a GPS to identify a route for traveling back and forth from a garage to the end of a driveway or street curb. Further, there is a long-felt need in the art for an automated trash can device that automates trash pickup from public sanitation employees, eliminating the need for homeowners to manually take their trash to the street curb. Moreover, there is a long-felt need in the art for a device that features a charging dock that stores the receptacle when it needs to be filled with trash. Further, there is a long-felt need in the art for an automated trash can device that prevents users from having to worry about their outdoor trash receptacles, ensuring they only move back and forth from two different locations. Finally, there is a long-felt need in the art for an automated trash device that provides users with a device that automates movement of their trash receptacles with minimal effort required by the user.

The present invention, in one exemplary embodiment, is a novel automated trash can device. The device is an improved trash can comprised of a base component with a battery component, a GPS, and a garage door opener. The device is wirelessly paired to a mobile application. The trash can device may be stored in a charging dock or station when being filled with trash and/or charging. In use, the trash can device will open the garage door, then proceed to the destination near the curb or end of the driveway. After being emptied, the trash can device then returns to the charging dock or station and closes the garage door. The present invention also includes a novel method of automatically moving a trash receptacle from a garage docking station to a street curb for trash pickup. The method includes the steps of providing an automated trash can device comprising a base component with a battery component, a GPS, and a garage door opener, wherein the device is wirelessly paired to a mobile application. The method also comprises filling the trash can device with bags of trash. Further, the method comprises programming the trash can device to open the garage door at a predetermined date and time. The method comprises optimizing the route for the trash can device via GPS, ensuring the device moves back and forth from the garage to the street curb correctly. Finally, activating the trash can device, which opens the garage door at a predetermined time and date, the device proceeds to the street curb, and after being emptied, returns to the charging station, and closes the garage door.

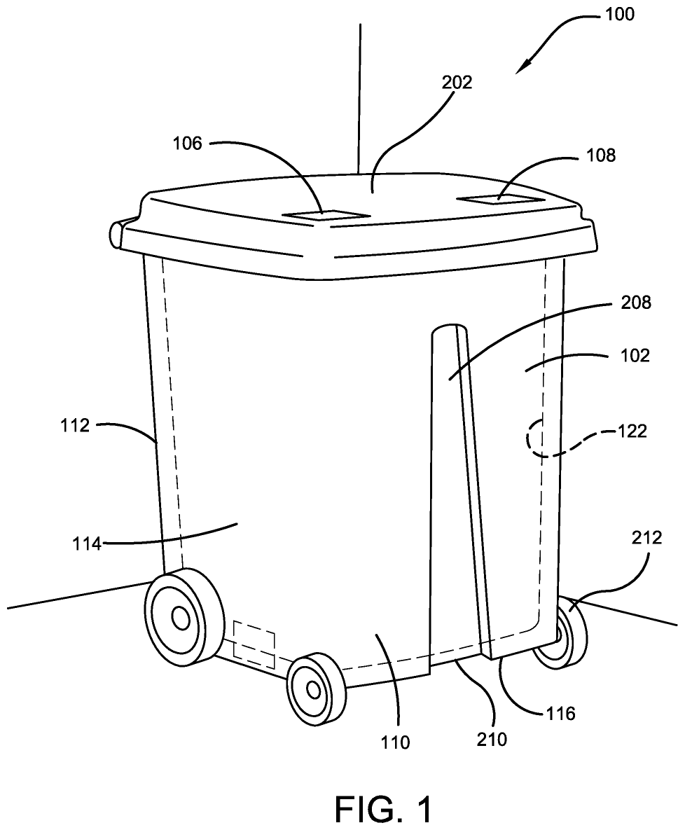

Referring initially to the drawings, FIG. 1 illustrates a perspective view of one embodiment of the automated trash can device 100 of the present invention. In the present embodiment, the automated trash can device 100 is an improved trash can that is fully automated by a user. Specifically, the device 100 comprises a base component 102 with a battery component 104, a GPS 106, and a garage door opener 108. Users automate the movement of the trash can device 100 with minimal effort required. Specifically, in use, the trash can device 100 will open the garage door, then proceed to the destination near the street curb or end of the driveway 400. After being emptied, the trash can device 100 then returns to the house or garage 402 and closes the garage door.

Further, the automated trash can device 100 comprises a base component 102 of varying sizes and shapes. Generally, the base component 102 is shaped as a rectangular prism, such as a conventional trash can, but can be any size and shape as is known to one of ordinary skill in the art, such as cylindrical, oval, square prism, etc. Typically, the base component 102 comprises a front wall 110, a rear wall 112, two opposing side walls 114, and a bottom component 116. The front wall 110, rear wall 112, two opposing side walls 114, and the bottom component 116 act to form a hollow interior cavity 118 and opening 120. The hollow interior cavity 118 is utilized for retaining trash, trash bags 200 filled with trash, and other items, which are placed within the opening 120 and into the hollow interior cavity 118.

In one embodiment, the base component 102 comprises an inner shell or liner component 122. The base component 102 can be made integrally, monolithically, or separate from the inner shell or liner 122. In some embodiments, the inner shell or liner component 122 can be removable. Typically, the inner shell or liner component 122 is made of the same material as the outer base component 102, but does not have to be and can be manufactured of any suitable material as is known in the art.

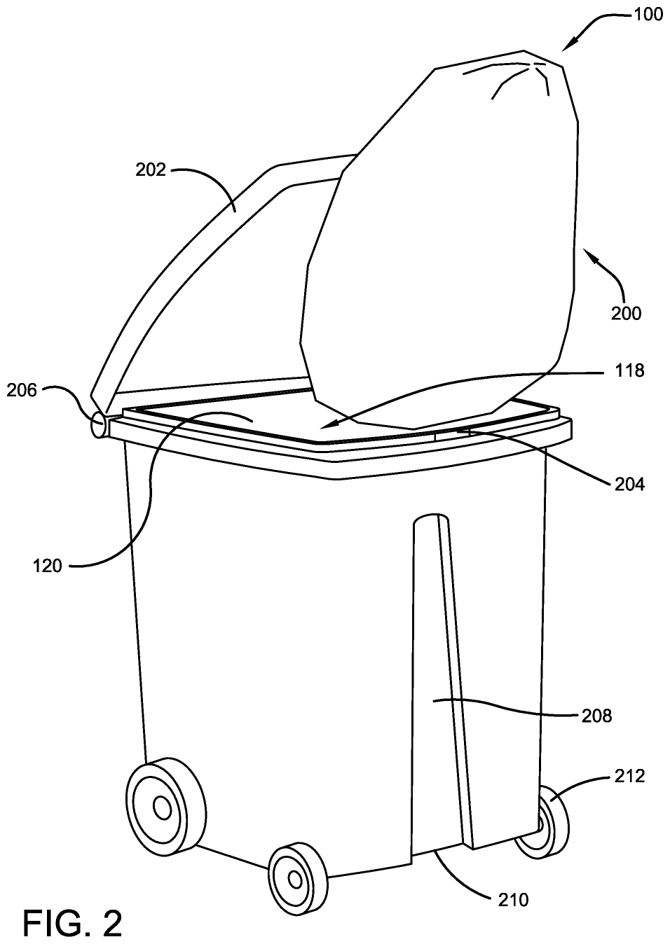

As shown in FIG. 2, the base component 102 further comprises a lid component 202 covering the opening 120. The lid component 202 acts to secure the contents of the trash can device 100 and can be secured via a press fit assembly, latch, lock, or other securing means 204 as is known in the art. Further, the lid component 202 comprises hinges 206 which act to allow opening and closing of the lid component 202 on the base component 102 and acts to allow access to the opening 120 and thus the hollow interior cavity 118 of the base component 102.

Further, the base component 102 can also include a foot recess 208 positioned at a lower portion of the base component 102. The foot recess 208 can be formed from a shaped portion of the base component 102 or can be made integrally with the bottom of the base component 102. The foot recess 208 can extend inwardly into the general outer periphery of the base component 102. Additionally, the foot recess 208 can extend upwardly from the bottom of the base component 102. Further, a foot plate 210 can be optionally provided at a bottom of the foot recess 208 and can extend from the bottom of the base component 102 to control opening and closing of the lid component 202 via a user pressing down on the foot plate 210.

Additionally, the base component 102 comprises a plurality of wheels 212. The plurality of wheels 212 may be disposed at a bottom component 116 of the base component 102 and may allow the automated trash can device 100 to roll in any direction. In other words, the plurality of wheels 212 may rotate, swivel, and pivot, based on a user's preference and/or commands. Specifically, the plurality of wheels 212 may rotate, swivel, and pivot when the motor is activated. The plurality of wheels 212 can be secured to an underside of the bottom component 116 via any suitable securing means as is known in the art, such as bolts, screws, pins, etc. Further, any suitable wheels 212 can be utilized as is known in the art, such as castors, rollers, swivel wheels, etc. Additionally, any suitable number of wheels 212 can be utilized as is known in the art, depending on the needs and/or wants of a user. In one embodiment, the plurality of wheels 212 are secured to a transport unit 213 and can be separated from the base component 102 if needed, to allow for ease in emptying the device 100 when full or for cleaning as needed. Thus, sanitation workers can easily release the base component 102 from the transport unit 213 when emptying the device 100 into the garbage truck. Users can also easily clean the base component 102 easier when not secured to the transport unit 213. The base component 102 would be secured to the transport unit 213 via any suitable securing means as is known in the art, such as spring clips, etc.

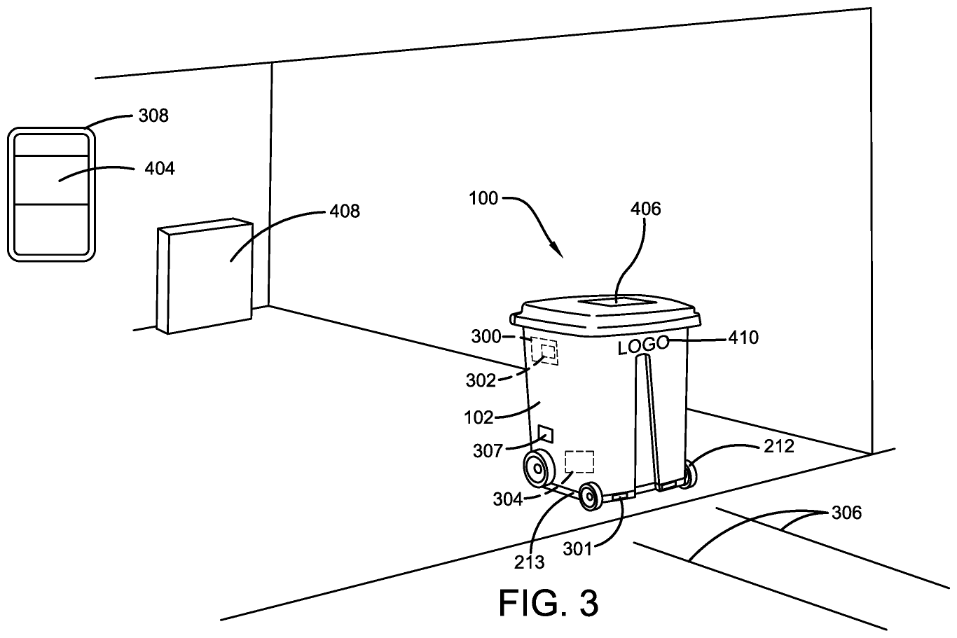

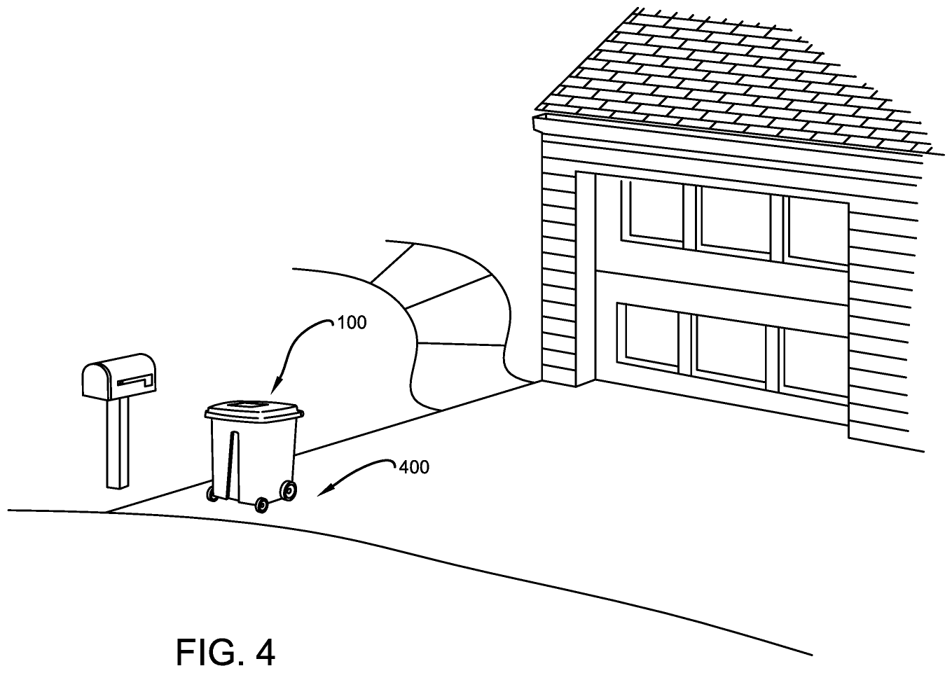

As shown in FIGS. 3 and 4, the base component 102 comprises a sensor component 300, a processor 302, and a motor 304, but is not limited thereto. The sensor component 300 may be disposed on the base component 102 and may communicate with a plurality of sensor guides 306, which may be placed along a path (i.e., a ground, a floor, a driveway, a street, etc.) in a particular direction and/or configuration. The sensor component 300 can also detect nearby objects to allow the device 100 to avoid such objects when in motion. Typically, the sensor component 300 could detect moving objects, such as people and animals, as well as stationary objects, such as rocks, trees, etc.

In one embodiment, the base component 102 comprises a plurality of exterior lights 301 or reflectors for use in the dark. Any suitable number of exterior lights 301 can be utilized as is known in the art, depending on the needs and/or wants of a user. The lights 301 and/or reflectors allow for ease in transport during lowlight or night time hours.

Further, the processor 302 may be disposed on or within the base component 102, and may be a CPU, a microprocessor, a controller, or any other type of computing device that may process programs and/or instructions, and which may control the other electrical components within the automated trash can device 100. The processor 302 may be connected to the sensor component 300 and the motor 304, such that the processor 302 causes the motor 304 to be activated (i.e., turned on) when the processor 302, which includes a transmitter/receiver 307, receives a signal from a mobile or smart device 308, for example.

Additionally, the motor 304 may be any suitable type of motor and/or control device to control the plurality of wheels 212 to rotate and pivot as is known in the art, depending on the needs and/or wants of a user.

Furthermore, the mobile device or smart device 308 may be a cellular telephone, a remote control, or any other device that may have wireless communication capabilities and may be connected to the Internet. The mobile or smart device 308 may perform any type of wireless communication, including, but not limited to, WIFI, BLUETOOTH, RFID, etc. The device 100 further includes a wireless communications module 310 and additional sensors which would allow the device 100 to pair with a mobile application 312 on the mobile or smart device 308. Once paired, a user could control the automated trash can device 100 via the mobile application 312.

As such, the user may use the mobile or smart device 308 to input and/or program a date and time that the automated trash can device 100 is scheduled to move down a path designated by the plurality of sensor guides 306, and a signal may be sent from the mobile device 308 to the transmitter/receiver 307 such that the processor 302 (which may include a storage device) stores the date and time that the automated trash can device 100 is scheduled to move. Alternatively, the mobile or smart device 308 may send a signal to the transmitter/receiver 307 to control the automated trash can device 100 to move immediately.

When the transmitter/receiver 307 receives the signal from the mobile or smart device 308 to control the automated trash can device 100 to move, the processor 302 may activate the motor 304, such that the plurality of wheels 212 begin rotating. The sensor component 300 causes the automated trash can device 100 to stay along a path designated by the plurality of sensor guides 306, such that the automated trash can device 100 may stay between the plurality of sensor guides 306. As such, the motor 304 may cause the plurality of wheels 212 to rotate and pivot, thereby causing the automated trash can device 100 to move along the path designated by the plurality of sensor guides 306 (i.e., between the plurality of sensor guides 306), until the automated trash can device 100 reaches an end of the path designated by the plurality of sensor guides 306. Likewise, the automated trash can device 100 may be programmed and/or controlled to return back to a beginning of the path designated by the plurality of sensor guides 306. In other words, the automated trash can device 100 may move back and forth along the path designated by the plurality of sensor guides 306, as needed.

In an alternative embodiment, the processor 302 may include a GPS unit 106 that may be programmed and/or controlled by the mobile or smart device 308 to move to a predetermined location based on an input of the user. In other words, the GPS unit 106 may a global positioning device that communicates with satellites in order to determine a location of the automated trash can device 100. The route of the device 100 is optimized via GPS 106, ensuring the trash can device 100 moves back and forth from the garage 402 to the curb/driveway 400 correctly. As such, the sensor component 300 and the plurality of sensor guides 306 may not be required when the GPS unit 106 is included in the processor 302. Also, a display screen 404 (which may also be an input unit/touch screen) on the mobile or smart device 308 may display the automated trash can device 100 on a map as it is moving.

Furthermore, the automated trash can device 100 may have an input unit 406 including buttons or a touch screen (preferably waterproof) disposed thereupon to program the processor 302 directly/manually, instead of requiring the processor 302 to communicate with the mobile or smart device 308.

Additionally, the base component 102 comprises a garage door opener 108 which acts to open and close the garage door, thus allowing a user to program the opening and/or closing of the garage door when the automated trash can device 100 needs to leave the home or garage 402 to travel down to the street curb 400 and back.

Furthermore, the base component 102 comprises a battery component 104. The battery component 104 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the trash can device 100. Throughout this specification, the term “battery” may be used interchangeably to refer to one or more wet or dry cells or batteries of cells in which chemical energy is converted into electricity and used as a source of DC power. References to recharging or replacing the battery 104 may refer to recharging or replacing individual cells, individual batteries of cells, or a package of multiple battery cells as is appropriate for any given battery technology that may be used. In addition, a rechargeable embodiment of the battery 104 may be recharged using a USB port (not shown), wherein the USB port is a USB-A, USB-B, Micro-B, Micro-USB, Mini-USB, or USB-C port, etc.

Additionally, the base component 102 rests on or against a charging dock or station 408 within a home or garage 402. The charging dock or station 408 can be any suitable shape or size and allows the device 100 to be stored on or against the station 408 and charged when not in use. The charging dock or station 408 recharges the battery component 104 and retains the device 100, allowing a user to fill the trash can device 100 with trash 200, as needed.

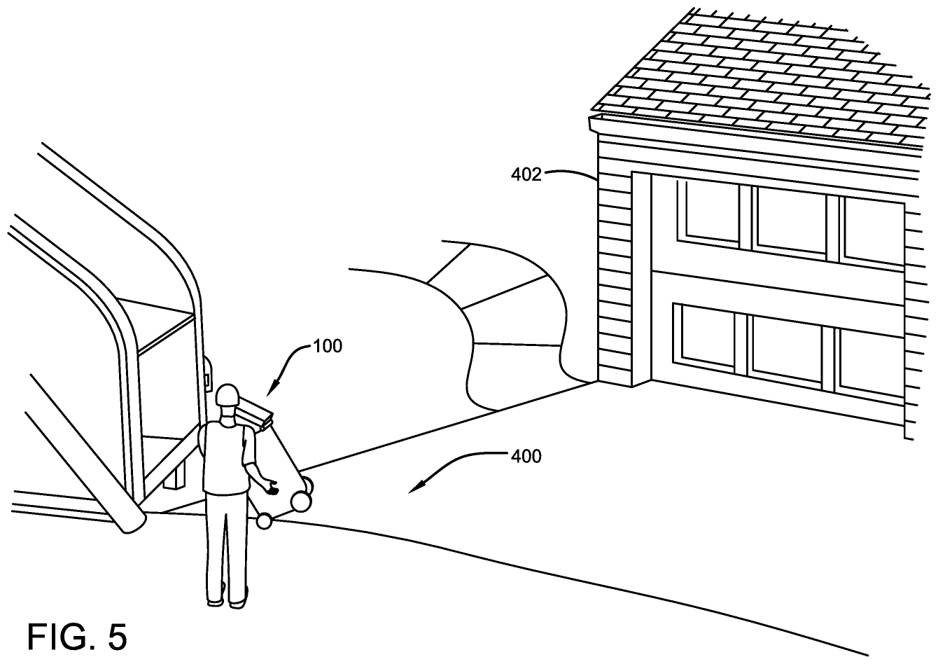

As shown in FIG. 5, the device 100 is an improved trash can device 100 that, in use, will open the garage door, then proceed to the destination near the curb or end of the driveway 400. After being emptied, the trash can device 100 then returns to the house or garage 402 and closes the garage door. Thus, users automate the movement of the trash can device 100 to the street curb/driveway 400 for pickup with minimal effort required.

Further, the automated trash can device 100 comprises a plurality of indicia 410. The base component 102 of the device 100 may include advertising, a trademark, or other letters, designs, or characters, printed, painted, stamped, or integrated into the base component 102, or any other indicia 410 as is known in the art. Specifically, any suitable indicia 410 as is known in the art can be included, such as, but not limited to, patterns, logos, emblems, images, symbols, designs, letters, words, characters, animals, advertisements, brands, etc., that may or may not be trash can or brand related.

The automated trash can device 100 is manufactured from light weight metals, such as aluminum and stainless steel, or heat-resistant plastics or polymers, such as polypropylene, polycarbonate, or acrylonitrile-butadiene-styrene (ABS), or any other suitable material as is known in the art, such as, but not limited to, polyethylene, thermoplastic, low density polyethylene, polyethylene terephthalate, polyvinyl chloride, polystyrene, polylactic acid, acetal, etc. Generally, the automated trash can device 100 is also manufactured from a material that is water resistant or water permeable, or the base component 102 comprises a coating that is water resistant or water permeable.

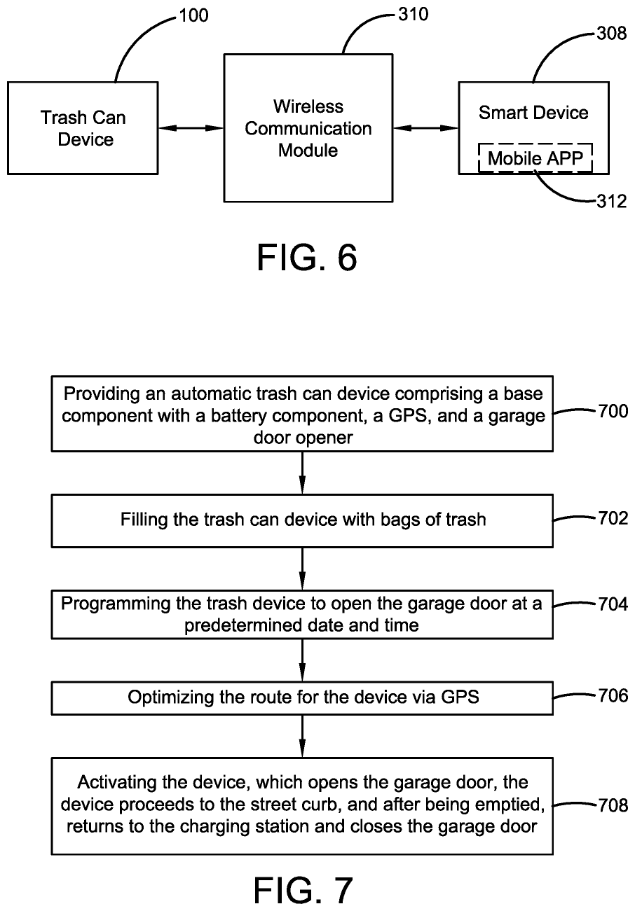

FIG. 6 illustrates a block diagram of the wireless communication module 310 in communication with a smart device 308 and the automated trash can device 100 of the present invention. The automated trash can device 100 includes a wireless communication module 310 and additional sensors which would allow the device 100 to pair with a mobile application 312 on a smart device 308. Once paired, a user could control the automated trash can device 100 via the mobile application 312.

FIG. 7 illustrates a flowchart of the method of automatically moving a trash receptacle from a garage docking station to a street curb for trash pickup. The method includes the steps of at 700, providing an automated trash can device comprising a base component with a battery component, a GPS, and a garage door opener, wherein the device is wirelessly paired to a mobile application. The method also comprises at 702, filling the trash can device with bags of trash. Further, the method comprises at 704, programming the trash can device to open the garage door at a predetermined date and time. The method comprises at 706, optimizing the route for the trash can device via GPS, ensuring the device moves back and forth from the garage to the street curb correctly. Finally, at 708, activating the trash can device, which opens the garage door at a predetermined time and date, the device proceeds to the street curb, and after being emptied, returns to the charging station, and closes the garage door.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “automated trash can device”, “trash can device”, and “device” are interchangeable and refer to the automated trash can device 100 of the present invention.

Notwithstanding the foregoing, the automated trash can device 100 of the present invention can be of any suitable size and configuration as is known in the art without affecting the overall concept of the invention, provided that it accomplishes the above-stated objectives. One of ordinary skill in the art will appreciate that the automated trash can device 100 as shown in FIGS. 1-7 is for illustrative purposes only, and that many other sizes and shapes of the automated trash can device 100 are well within the scope of the present disclosure. Although the dimensions of the automated trash can device 100 are important design parameters for user convenience, the automated trash can device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An automated trash can device that can automatically move from a garage to a street curb, the automated trash can device comprising:
a base component;
a plurality of wheels;
a garage door opener;
a battery component; and
a sensor component, a processor, and a motor disposed on the base component;
wherein the automated trash can device will open a garage door, then proceed to a street curb;
wherein after the automated trash can device is emptied, the automated trash can device returns to the garage and closes the garage door; and
further wherein trash is retained within the automated trash can device.

2. The automated trash can device of claim 1, wherein the base component comprises a front wall, a rear wall, two opposing side walls, and a bottom component.

3. The automated trash can device of claim 2, wherein the front wall, the rear wall, two opposing side walls, and the bottom component act to form a hollow interior cavity and an opening.

4. The automated trash can device of claim 3, wherein the base component comprises an inner liner and a plurality of exterior lights.

5. The automated trash can device of claim 4, wherein the base component comprises a lid component with hinges.

6. The automated trash can device of claim 5, wherein the base component comprises a foot recess with a foot plate for controlling opening and closing of the lid component.

7. The automated trash can device of claim 6, wherein the sensor component communicates with a plurality of sensor guides which are placed along a path in a particular direction and configuration and senses nearby objects.

8. The automated trash can device of claim 7, wherein the processor may be connected to the sensor component and the motor, such that the processor causes the motor to be activated when the processor, which includes a transmitter/receiver, receives a signal from a smart device, which then activates the plurality of wheels.

9. The automated trash can device of claim 8 wherein the automated trash can device comprises a wireless communications module and additional sensors which allow the automated trash can device to pair with a mobile application on the smart device.

10. The automated trash can device of claim 9, wherein once paired, a user can control the automated trash can device via the mobile application.

11. The automated trash can device of claim 1, wherein the processor comprises a GPS unit that may be programmed or controlled by the smart device to move to a predetermined location based on an input of the user.

12. The automated trash can device of claim 11, wherein the base component comprises an input unit including a touch screen to program the processor directly, instead of requiring the processor to communicate with the smart device.

13. The automated trash can device of claim 12, wherein the base component rests on or against a charging dock within a home or garage to charge the automated trash can device.

14. An automated trash can device that can automatically move from a garage to a street curb, the automated trash can device comprising:
a base component;
a plurality of wheels connected to a transport unit that can be separated from the base component;
a garage door opener;
a battery component; and
a sensor component, a processor, and a motor disposed on the base component;
wherein the automated trash can device will open a garage door, then proceed to a street curb;
wherein after the automated trash can device is emptied, the automated trash can device returns to the garage and closes the garage door; and
wherein the automated trash can device further comprises a wireless communications module and additional sensors which allow the automated trash can device to pair with a mobile application on the smart device;
wherein once paired, a user can control the automated trash can device via the mobile application; and
wherein the processor comprises a GPS unit that may be programmed or controlled by the smart device to move to a predetermined location based on an input of the user; and
wherein the base component rests on or against a charging dock within a home or garage to charge the automated trash can device.

15. The automated trash can device of claim 14 further comprising a plurality of indicia.

16. The automated trash can device of claim 14, wherein the base component comprises an input unit including a touch screen to program the processor directly, instead of requiring the processor to communicate with the smart device.

17. The automated trash can device of claim 14, wherein the base component comprises a lid component with hinges.

18. The automated trash can device of claim 14, wherein the base component comprises a foot recess with a foot plate for controlling opening and closing of the lid component.

19. The automated trash can device of claim 14, wherein the processor may be connected to the sensor component and the motor, such that the processor causes the motor to be activated when the processor, which includes a transmitter/receiver, receives a signal from a smart device, which then activates the plurality of wheels.

20. A method of automatically moving a trash receptacle from a garage docking station to a street curb for trash pickup, the method comprising the steps of:
providing an automated trash can device comprising a base component with a battery component, a GPS, and a garage door opener, wherein the device is wirelessly paired to a mobile application;
filling the trash can device with bags of trash;
programming the trash can device to open the garage door at a predetermined date and time;
optimizing the route for the trash can device via GPS, ensuring the device moves back and forth from the garage to the street curb correctly; and
activating the trash can device, which opens the garage door at a predetermined time and date, the device proceeds to the street curb, and after being emptied, returns to the charging station and closes the garage door.
